(19) United States
(12) Patent Application Publication
(10) Pub. No.: US 2026/0341245 A1
(43) Pub. Date: Oct. 29, 2026

(54) DRIVING METHOD OF DISPLAY PANEL FOR REDUCING SCREEN FLICKERING CAUSED BY NOISES

(71) Applicant: Novatek Microelectronics Corp., Hsinchu (TW)

(72) Inventor: BoWen Fan, Hsinchu County (TW)

(73) Assignee: Novatek Microelectronics Corp., Hsinchu (TW)

(21) Appl. No.: 19/189,230

(22) Filed: Apr. 24, 2025

(51) Int. Cl. G09G 3/36

(52) U.S. Cl. CPC G09G 3/3614; G09G 3/3688; G09G 2320/0247

(57) ABSTRACT

A driving method configured to drive a display panel to display images is provided. The driving method includes: receiving a data signal from a video source via a connecting line, and detecting a noise signal on the connecting line; and outputting a pixel voltage having a same polarity in a current frame and a previous frame to drive the display panel when the noise signal is detected.

### BACKGROUND

### Technical Field

The invention generally relates to a driving method and a driving circuit. More particularly, the invention relates to a driving method and a driving circuit for driving a display panel.

### Description of Related Art

LCD displays are susceptible to irregular noise when subjected to signal interference. In order to reduce the noise interference, the driver IC adopts the TFT gate masking method to prevent the video data subjected to the noise interference from applying to the pixel electrodes. Since there is no signal in the GOA architecture to mask the TFT gate, the driver IC adopts the method of masking gate clock signals to avoid the wrong video data applying to the pixel electrodes.

Due to the property of LCD requiring polarity inversion, after masking the gate clock signals for one frame, the pixel electrodes in the display area will have three consecutive frames of non-inversion of polarity, resulting in a long time charge accumulation, and the image quality problem will be caused by the light/dark change when charging with the same polarity. Therefore, The screen flickering of the display panel caused by noises may occur to reduce the image quality.

### SUMMARY

The invention is directed to a driving method and a driving circuit, capable of reducing screen flickering of a display panel caused by noises.

An embodiment of the invention provides a driving method configured to drive a display panel to display images. The driving method includes: receiving a data signal from a video source via a connecting line, and detecting a noise signal on the connecting line; and outputting a pixel voltage having a same polarity in a current frame and a previous frame to drive the display panel when the noise signal is detected.

An embodiment of the invention provides a driving circuit configured to drive a display panel to display images. The driving circuit includes a detecting circuit and a source driving circuit. The detecting circuit is coupled to a video source via a connecting line. The detecting circuit is configured to receive a data signal from the video source via the connecting line, and detect a noise signal on the connecting line. The source driving circuit is coupled to the detecting circuit and the display panel. The source driving circuit is configured to output a pixel voltage to drive the display panel. The pixel voltage has the same polarity in a current frame and a previous frame when the noise signal is detected.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram illustrating a display apparatus according to an embodiment of the invention.

FIG. 2 is a schematic diagram illustrating that the display panel is driven in the manner of column inversion when the noise signal is not detected according to an embodiment of the invention.

FIG. 3 illustrates waveforms of pixel voltages and corresponding polarities when the noise signal is not detected according to an embodiment of the invention.

FIG. 4 is a schematic diagram illustrating that the display panel is driven in the manner of column inversion when the noise signal is detected according to an embodiment of the invention.

FIG. 5 illustrates waveforms of pixel voltages and corresponding polarities when the noise signal is detected according to an embodiment of the invention.

FIG. 6 is a schematic diagram illustrating that the display panel is driven in the manner of frame inversion when the noise signal is not detected according to an embodiment of the invention.

FIG. 7 illustrates waveforms of pixel voltages and corresponding polarities when the noise signal is not detected according to an embodiment of the invention.

FIG. 8 is a schematic diagram illustrating that the display panel is driven in the manner of frame inversion when the noise signal is detected according to an embodiment of the invention.

FIG. 9 illustrates waveforms of pixel voltages and corresponding polarities when the noise signal is detected according to an embodiment of the invention.

FIG. 10 is a flowchart illustrating steps in a driving method according to an embodiment of the invention.

### DESCRIPTION OF THE EMBODIMENTS

Embodiments are provided below to describe the disclosure in detail, though the disclosure is not limited to the provided embodiments, and the provided embodiments can be suitably combined. The term “coupling/coupled” or “connecting/connected” used in this specification (including claims) of the application may refer to any direct or indirect connection means. For example, “a first device is coupled to a second device” should be interpreted as “the first device is directly connected to the second device” or “the first device is indirectly connected to the second device through other devices or connection means.” The term “signal” can refer to a current, a voltage, a charge, a temperature, data, electromagnetic wave or any one or multiple signals. In addition, the term “and/or” can refer to “at least one of”. For example, “a first signal and/or a second signal” should be interpreted as “at least one of the first signal and the second signal”.

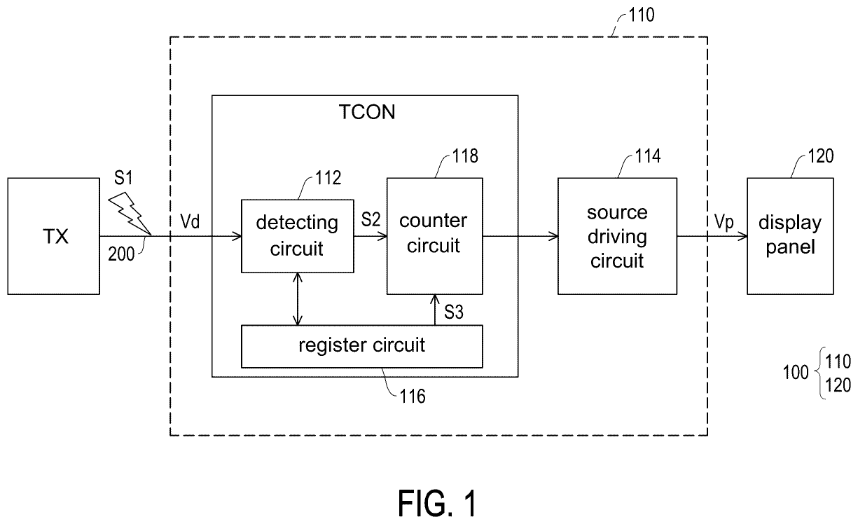

FIG. 1 is a block diagram illustrating a display apparatus according to an embodiment of the invention. Referring to FIG. 1, the display device 100 includes a driving circuit 110 and a display panel 120. The driving circuit 110 is configured to drive the display panel 120 to display images. The driving circuit 110 can drive the display panel 120 in a manner of column inversion, frame inversion, or dot inversion. The dot inversion includes 1+2 dot inversion or N dot inversion, wherein N=2, 4, 8, 16, 32 and so on. In an embodiment, the driving circuit 110 may be a display driver integrated circuit (D DIC), but the invention is not limited thereto.

To be specific, the driving circuit 110 includes a detecting circuit 112, a source driving circuit 114, a register circuit 116, and a counter circuit 118. The source driving circuit 114 is coupled to the display panel 120. The source driving circuit 114 is configured to output a pixel voltage Vp to drive the display panel 120 to display images. The source driving circuit 114 may include a plurality of source output buffers, and each of the source output buffers is configured to drive corresponding pixel columns of the display panel 120.

The detecting circuit 112 is coupled to a video source TX via a connecting line 200. The detecting circuit 112 is configured to receive a data signal Vd from the video source TX via the connecting line 200. The detecting circuit 112 is configured to detect whether a noise signal S1 exists on the connecting line 200, wherein the noise signal S1 may cause the driving circuit 110 to receive wrong data. Next, the detecting circuit 112 is further configured to inform the counter circuit 118 whether the noise signal S1 is detected. The counter circuit 118 determines the priority output of the next frame according to the register setting.

The noise signal S1 may be any noise or glitch signals occurring on the external connecting line 200. In an embodiment, the noise signal S1 may be electrostatic discharge (ESD) interference, but the invention is not limited thereto.

The register circuit 116 is coupled to the detecting circuit 112 and the counter circuit 118. The register circuit 116 is configured to store a flag. The flag is configured to indicate whether the noise signal S1 is detected. For example, the flag is set as a first value “1” to indicate that the noise signal S1 is detected, and the flag is set as a second value “0” to indicate that the noise signal S1 is not detected. The setting value of the flag is not intended to limit the invention. The value of the flag may be set by the detecting circuit 112 or other control circuits.

The counter circuit 118 is coupled to the detecting circuit 112 and the register circuit 116. The counter circuit 118 is configured to count a value of frames according to a vertical synchronization signal S2. The counter circuit 118 stops counting the value of the frames when the noise signal S1 is detected, and continuously counts the value of the frames when the noise signal S1 is not detected.

In the present embodiment, the register circuit 116 outputs an enable signal S3 to control an operation of the counter circuit 118. For example, the register circuit 116 may set the enable signal S3 as the first value “1” according to the flag, and the enable signal S3 set as the first value “1” can stop the counter circuit 118 when the noise signal S1 is detected. On the other hand, the register circuit 116 may set the enable signal S3 as the second value “0” according to the flag, and the enable signal S3 set as the second value “0” does not stop the counter circuit 118 when the noise signal S1 is not detected.

Enough teaching, suggestion, and implementation illustration for hardware structures of the driving circuit 110 and the display panel 120 can be obtained with reference to common knowledge in the related art. In addition, in an embodiment, the detecting circuit 112 and/or the register circuit 116 may be independently arranged outside of the driving circuit 110.

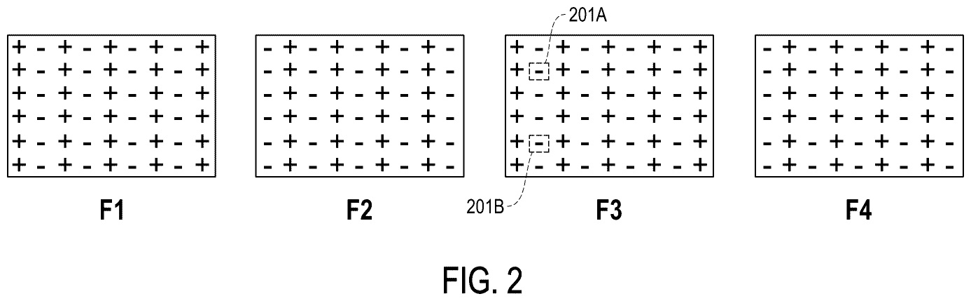

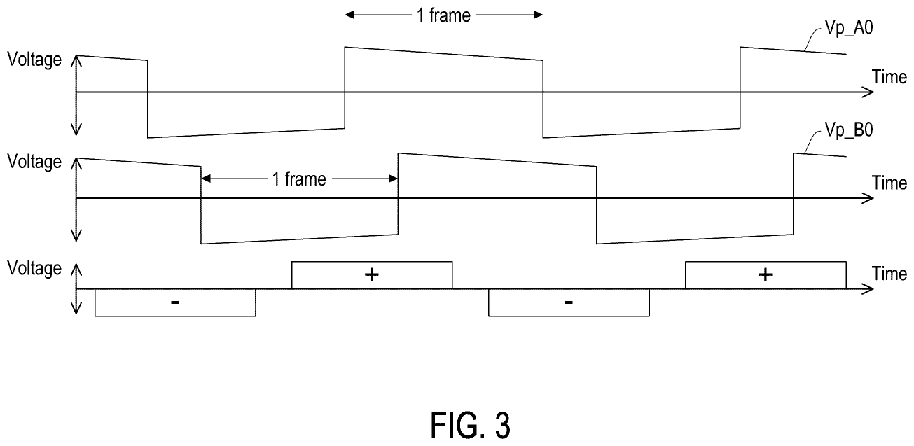

FIG. 2 is a schematic diagram illustrating that the display panel is driven in the manner of column inversion when the noise signal is not detected according to an embodiment of the invention. FIG. 3 illustrates waveforms of pixel voltages and corresponding polarities when the noise signal is not detected according to an embodiment of the invention.

Referring to FIG. 1 to FIG. 3, frames F1 to F4 are four continuous frames. The pixel voltage Vp_A0 is configured to drive the pixel 201A, and the pixel voltage Vp_B0 is configured to drive the pixel 201B. The pixel 201A and 201B are located in the same even pixel column of the display panel 120. The polarities of the pixel voltages Vp_A0 and Vp_B0 alternately switch during the four continuous frames F1 to F4 when the noise signal S1 is not detected. In the present embodiment, the counter circuit 118 does not stop counting the value of the frames since the noise signal S1 is not detected. The source driving circuit 114 outputs the pixel voltage Vp_A0, which has different polarities in the frames F2 and F3. Similarly, the pixel voltage Vp_B also has different polarities in the frames F2 and F3.

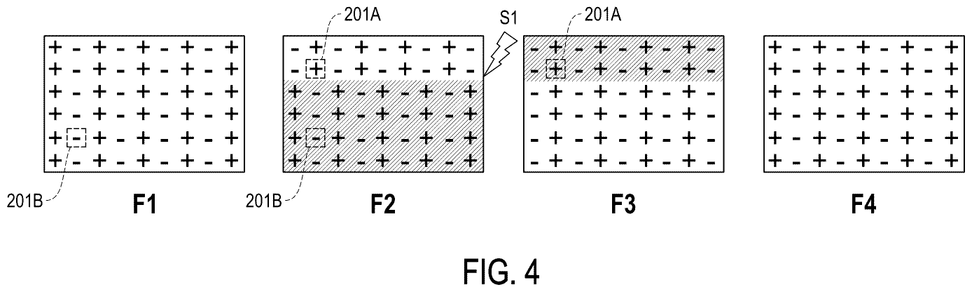

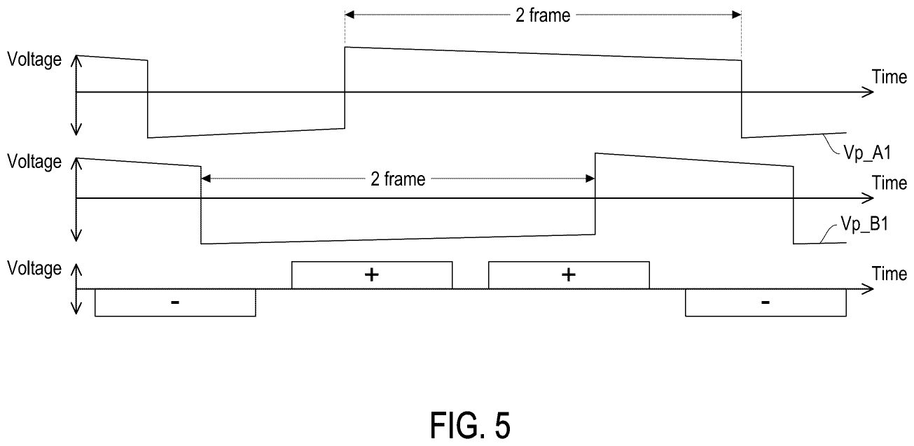

FIG. 4 is a schematic diagram illustrating that the display panel is driven in the manner of column inversion when the noise signal is detected according to an embodiment of the invention. FIG. 5 illustrates waveforms of pixel voltages and corresponding polarities when the noise signal is detected according to an embodiment of the invention.

Referring to FIG. 1, FIG. 4 and FIG. 5, the counter circuit 118 stops counting the value of the frames when the noise signal S1 is detected in the frame F2. In the present embodiment, the source driving circuit 114 outputs the pixel voltage having the same polarity in a current frame and a previous frame.

For the pixel voltage Vp_A1, taking the frame F3 as a current frame for example, the frame F2 is a frame previous to the current frame F3. The source driving circuit 114 outputs the pixel voltage Vp_A1 having the same polarity in the current frame F3 and the previous frame F2. The positive polarity of the pixel voltage Vp_A1 is maintained unchanged for two frame periods.

For the pixel voltage Vp_B1, taking the frame F2 as a current frame for example, the frame F1 is a frame previous to the current frame F2. The source driving circuit 114 outputs the pixel voltage Vp_B1 having the same polarity in the current frame F2 and the previous frame F1. The negative polarity of the pixel voltage Vp_B1 is maintained unchanged for two frame periods.

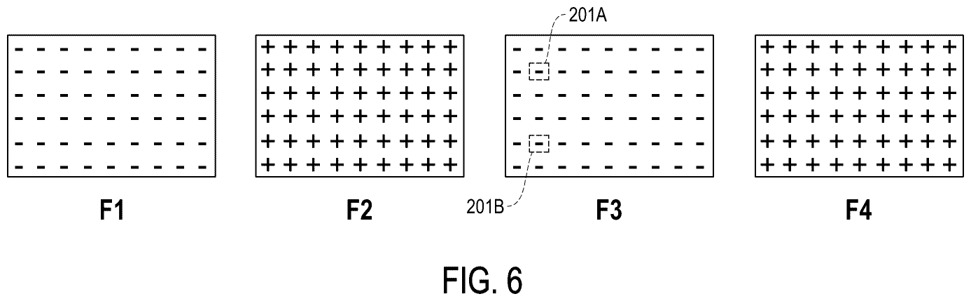

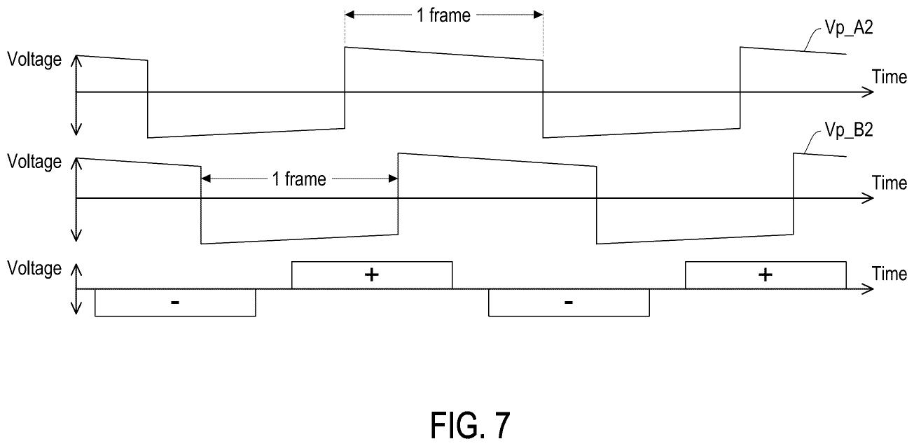

FIG. 6 is a schematic diagram illustrating that the display panel is driven in the manner of frame inversion when the noise signal is not detected according to an embodiment of the invention. FIG. 7 illustrates waveforms of pixel voltages and corresponding polarities when the noise signal is not detected according to an embodiment of the invention.

Referring to FIG. 1, FIG. 6 and FIG. 7, the polarities of the pixel voltages Vp_A2 and Vp_B2 alternately switch during the four continuous frames F1 to F4 when the noise signal S1 is not detected. In the present embodiment, the counter circuit 118 does not stop counting the value of the frames since the noise signal S1 is not detected. The source driving circuit 114 outputs the pixel voltage Vp_A2, which has different polarities in the frames F2 and F3. Similarly, the pixel voltage Vp_B2 also has different polarities in the frames F2 and F3.

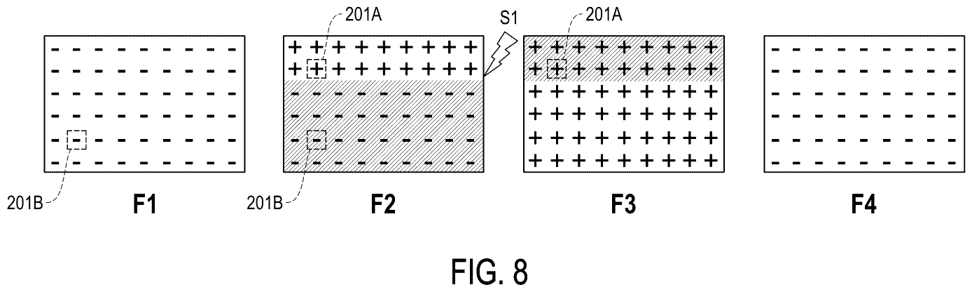

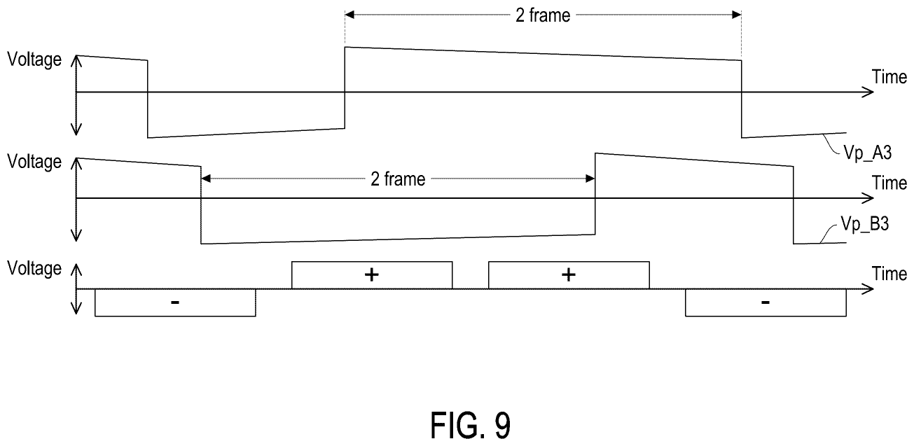

FIG. 8 is a schematic diagram illustrating that the display panel is driven in the manner of frame inversion when the noise signal is detected according to an embodiment of the invention. FIG. 9 illustrates waveforms of pixel voltages and corresponding polarities when the noise signal is detected according to an embodiment of the invention.

Referring to FIG. 1, FIG. 8 and FIG. 9, the counter circuit 118 stops counting the value of the frames when the noise signal S1 is detected in the frame F2. For the pixel voltage Vp_A3, the source driving circuit 114 outputs the pixel voltage Vp_A3 having the same positive polarity in the current frame F3 and the previous frame F2. For the pixel voltage Vp_B3, the source driving circuit 114 outputs the pixel voltage Vp_B3 having the same negative polarity in the current frame F2 and the previous frame F1.

In addition, the driving method of the dot inversion can be deduced in the similar manner, and therefore no further description is provided herein.

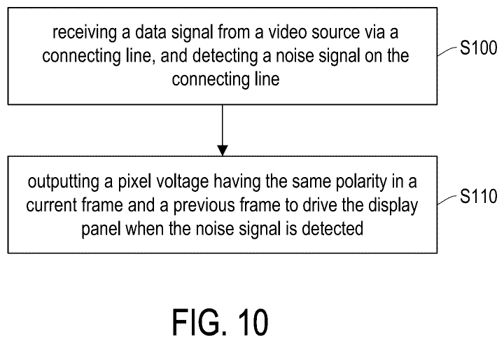

FIG. 10 is a flowchart illustrating steps in a driving method according to an embodiment of the invention. Referring to FIG. 1 and FIG. 10, the driving method is at least adapted to the display device 100 depicted in FIG. 1, but the invention is not limited thereto. Taking the display device 100 for example, in step S100, the detecting circuit 112 receives a data signal Vd from a video source TX via a connecting line 200, and detects a noise signal S1 on the connecting line 200. In step S110, the source driving circuit 114 outputs a pixel voltage Vp having the same polarity in a current frame and a previous frame to drive the display panel 120 when the noise signal S1 is detected.

The driving method described in the embodiment of the invention is sufficiently taught, suggested, and embodied in the embodiments illustrated in FIG. 1 to FIG. 9, and therefore no further description is provided herein.

In summary, in the embodiment of the invention, when the noise signal is detected, the driving circuit stop counting the value of the frames, and outputs the pixel voltage having the same polarity in the current frame and the previous frame to drive the display panel.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

1. A driving method, configured to drive a display panel to display images, the driving method comprising:
receiving a data signal from a video source via a connecting line, and detecting a noise signal on the connecting line; outputting a pixel voltage having a same polarity in a current frame and a previous frame to drive the display panel when the noise signal is detected;
counting a value of frames according to a vertical synchronization signal;
stopping counting the value of the frames when the noise signal is detected; and
continuously counting the value of the frames when the noise signal is not detected.

2. (canceled)

3. The driving method according to claim 1, further comprising:
setting a flag as a first value to indicate that the noise signal is detected; and
setting the flag as a second value to indicate that the noise signal is not detected.

4. The driving method according to claim 3, further comprising:
generating the pixel voltage having the same polarity in the current frame as the polarity in the previous frame when the flag is set as the first value.

5. The driving method according to claim 1, further comprising:
driving the display panel in a manner of column inversion.

6. The driving method according to claim 1, further comprising:
driving the display panel in a manner of frame inversion.

7. The driving method according to claim 1, further comprising:
driving the display panel in a manner of dot inversion.

8. A driving circuit, configured to drive a display panel to display images, the driving circuit comprising:
a detecting circuit, coupled to a video source via a connecting line, and configured to receive a data signal from the video source via the connecting line, and detect a noise signal on the connecting line; a source driving circuit, coupled to the detecting circuit, and configured to output a pixel voltage to drive the display panel, wherein the pixel voltage has a same polarity in a current frame and a previous frame when the noise signal is detected; and
a counter circuit, coupled to the detecting circuit and the register circuit, and configured to count a value of frames according to a vertical synchronization signal, stop counting the value of the frames when the noise signal is detected, and continuously count the value of the frames when the noise signal is not detected.

9. The driving circuit according to claim 8, further comprising:
a register circuit, coupled to the detecting circuit, and configured to store a flag, wherein the flag is configured to indicate whether the noise signal is detected.

10. (canceled)

11. The driving circuit according to claim 9, wherein the flag is set as a first value to indicate that the noise signal is detected, and the flag is set as a second value to indicate that the noise signal is not detected.

12. The driving circuit according to claim 9, wherein the source driving circuit generates the pixel voltage having the same polarity in the current frame as the polarity in the previous frame when the flag is set as the first value.

13. The driving circuit according to claim 8, wherein the source driving circuit drives the display panel in a manner of column inversion.

14. The driving circuit according to claim 8, wherein the source driving circuit drives the display panel in a manner of frame inversion.

15. The driving circuit according to claim 8, wherein the source driving circuit drives the display panel in a manner of dot inversion.
